(19) United States
(12) Patent Application Publication
(10) Pub. No.: US 2021/0094763 A1
(43) Pub. Date: Apr. 1, 2021

(54) APPARATUS FOR TRANSPORT AND CONTROLLED DISCHARGE OF PRODUCTS

(71) Applicant: Eurosort B.V, 'S-Graveland (NL)

(72) Inventors: Patrick Theodorus Johannes Van Haaster, De Zilk (NL); Wiebe De Jong, Amsterdam (NL)

(21) Appl. No.: 17/031,552

(22) Filed: Sep. 24, 2020

(30) Foreign Application Priority Data
Sep. 27, 2019 (EP) 19200063.6
Oct. 15, 2019 (EP) 19203267.0

(51) Int. Cl. B65G 43/08; B65G 17/34

(52) U.S. Cl. CPC B65G 43/08; B65G 2207/18; B65G 17/345

(57) ABSTRACT

An apparatus for transport and controlled discharge of product comprises at least a transport unit including an upper surface for a product, a loading station, a discharging station and a drive for transporting the transport unit in a conveying direction. The transport unit comprises a pushing member for pushing a product from the upper surface in transverse direction of the conveying direction at the discharging station, a pushing member guide for guiding the pushing member in the transverse direction between first and second extreme positions for removing a product. A control system selective drives the pushing member along the pushing member guide during movement of the transport unit in the conveying direction. The control system is adapted such that at least at the loading station the pushing member is located at an intermediate position between the first extreme position and the second extreme position.

### BACKGROUND

The discussion below is merely provided for general background information and is not intended to be used as an aid in determining the scope of the claimed subject matter.

Aspects of the invention relate to an apparatus for transport and controlled discharge of products, comprising at least a transport unit including an upper surface for supporting a product, a loading station where a product can be placed on the upper surface, a discharging station where a product can be discharged from the upper surface and a drive for transporting the transport unit in a conveying direction from the loading station to the discharging station, wherein the transport unit comprises a pushing member for pushing a product from the upper surface in transverse direction of the conveying direction when the transport unit is at the discharging station, a pushing member guide for guiding the pushing member in the transverse direction between a first extreme position and a second extreme position for removing a product from the upper surface when the pushing member is moved in a direction from the first extreme position to the second extreme position and a control system for selectively driving the pushing member along the pushing member guide during movement of the transport unit in the conveying direction.

Such an apparatus is known from DE 199 59 843. The known apparatus comprises a pushing member at each of the transport units for pushing a product from the upper surface of the transport unit. At the loading station the pushing member is located at the first extreme position such that an operator can place a product onto the upper surface. The control system can selectively drive the pushing member along the pushing member guide during movement of the transport unit in the conveying direction in order to discharge a product at a desired location at the discharging station. The displacement of the pushing member from the first to the second extreme position takes a certain period of time, i.e. a certain travelling distance of the transport unit in the conveying direction. Depending on the dimensions of the product and the location of the product on the upper surface in the transverse direction the exact location where the product leaves the transport unit at the discharging station during a displacement of the pushing member may vary. This requires a certain length of a receiving unit for receiving a discharged product at the discharging station as measured in the conveying direction. The known apparatus has a plurality of transport units and a plurality of receiving units at the discharging station so as to sort products for different destinations. This means that the required total length of the receiving units may form a considerable part of the apparatus.

The known apparatus may be applied for transporting and sorting products which have a maximum dimension which is relatively small with respect to the upper surface between the first extreme position and the second extreme position in the transverse direction. For handling such a product range transport units which have dedicated dimensions in the transverse direction may be applied. However, it may be efficient to use the same type of apparatus for product ranges having different maximum dimensions because of using standardized dimensions of at least a part of its components, although it is in fact over-dimensioned for handling the products of relatively small sizes.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the present invention provides an apparatus for transport and controlled discharge of products which is optimized for handling products which have a maximum dimension that is relatively small with respect to the distance between the first and second extreme positons.

In order to achieve this object the control system is adapted such that at least at the loading station the pushing member is located at an intermediate position between the first extreme position and the second extreme position.

In the apparatus, the pushing member guide allows the pushing member to move between the first and second extreme positions, but the control system forces the pushing member to the intermediate position at at least the loading station. This creates a limited region of the upper surface between the first extreme position and the second extreme position which may be sufficient for receiving products which have a maximum dimension that is relatively small to the distance between the first and second extreme positions. The presence of the pushing member in the intermediate position urges an operator at the loading station to place a product within the limited region. Since a product is located at the well-defined limited region the length of the path along which products may leave the transport unit at the discharging station is relatively small. Consequently, a receiving unit for receiving a discharged product from the transport unit being located next to the path along which the transport unit travels, can be relatively short as measured in the conveying direction. In other words, they can be located closer to each other in the conveying direction. Hence, the apparatus can be optimized for handling products which have a maximum dimension that is relatively small to the distance between the first and second extreme positions, whereas standardized components can be used, such as the transport units including the pushing members and the pushing member guides. Furthermore, the limited region also prevents an operator from placing a too large product on the transport unit at the loading station.

The intermediate position may be closer to the first extreme position than the second extreme position such that the largest portion of the upper surface between the first and second extreme positions can still be used for receiving a product at the loading station.

The control system may be adapted such that the pushing member is located at the first extreme position or between the first extreme position and the intermediate position when the actual position of the transport unit is upstream of the loading station.

In a particular embodiment the control system is adapted such that the pushing member is located at the first extreme position or between the first extreme position and the intermediate position when the transport unit arrives at the discharging station. In this case the pushing member is moved back in a direction from the intermediate position to the first extreme position between the loading station and the discharging station. Independent from the selected intermediate position on the basis of the maximum size of a product from a product range to be transported, the pushing member may always have the same position when the transport unit arrives at the discharging station. This means that a part of the control system which selectively drives the pushing member along the pushing member for discharging a product from the transport unit at the discharging station may be similar for two apparatus which handle products of different size ranges. This is advantageous in view of using standardized components.

In a practical embodiment the apparatus comprises a loop-shaped transport path such that the transport unit successively follows the transport path from the loading station to the discharging station and back to the loading station.

The control system may be provided with an offset guide which is located at least upstream of the loading station and adapted such that it guides the pushing member to the intermediate position upon passing the offset guide. This is a simple structure to bring the pushing member in the intermediate position.

The offset guide may be adapted such that it guides the pushing member from the first extreme position to the intermediate position upon passing the offset guide.

In a practical embodiment the control system is provided with a plurality of oblique guides located at a distance from each other in the conveying direction at the discharging station and cooperating switchable guide actuators for selectively directing an actuator element of the pushing member of the passing transport unit to the corresponding oblique guide so as to guide the actuator element of the pushing member along the selected oblique guide upon passing the selected oblique guide. This allows the control system to selectively drive the pushing member along the pushing member guide during movement of the transport unit in the conveying direction. The actuator element may be an actuator wheel which is rotatably mounted to the pushing member in order to minimize friction between the oblique guides and the pushing member. If the position of the pushing member upon arrival at the discharging station is always the same, independent from the selection of the intermediate position, the location of the switchable guide actuators may be unchanged for different apparatus intended for handling product ranges have a different maximum product size.

In a particular embodiment the apparatus is provided with receiving units at the discharging station, wherein the length of each of the receiving units in the conveying direction is smaller than the distance between two successive oblique guides in the conveying direction. Since the pushing member can only touch a product on the upper surface between the intermediate position and the second extreme position the lengths of the receiving units may be relatively small.

In an alternative embodiment the distance between two successive oblique guides in the conveying direction is smaller than a travelling distance of the transport unit in the conveying direction for displacing the pushing member from the first extreme position to the second extreme position. The travelling distance of the transport unit in the conveying direction for displacing the pushing member from the first extreme position to the second extreme position depends on the angle of inclination of the respective oblique guides.

The distance between two successive oblique guides in the conveying direction may be equal to or larger than the travelling distance of the transport unit in the conveying direction for displacing the pushing member from the intermediate position to the second extreme position.

In a particular embodiment the pushing member is provided with a pushing element for pushing a product from the upper surface in transverse direction of the conveying direction when the transport unit is at the discharging station and with a flexible cross-belt to which the pushing element is mounted, which cross-belt is drivable in the transverse direction. The pushing element and the cross-belt are movable together in the transverse direction such that the pushing element is movable in the transverse direction between the first and second extreme positions. The pushing element may be an elongate bar or the like. In order to drive the cross-belt in the transverse direction the cross-belt may be provided with a slider which is movable along the pushing member guide, such that the cross-belt forms a transmission between the pushing element and the slider but alternative embodiments are conceivable.

The cross-belt may be adapted such that the upper surface for supporting a product is formed by an upper surface of the cross-belt next to the pushing element such that the pushing element is suitable for pushing against a product on the cross-belt in the event that a product on the cross-belt tends to move with respect to the cross-belt in opposite direction of the direction in which the cross-belt moves. This embodiment may be indicated as a cross-belt sorter. Under operating conditions, a product on the upper surface of the cross-belt next to the pushing element can be discharged from the upper surface by driving the cross-belt without any contact between the pushing element and the product. However, the pushing element is mounted to the cross-belt for pushing against a product on the cross-belt in the event that a product on the cross-belt tends to move with respect to the cross-belt in opposite direction of the direction in which the cross-belt moves, for example caused by rolling or slipping. Similar to the embodiments as described hereinbefore, when the pushing element is located at the intermediate position at the loading station a product can be placed on the conveyor belt next to the pushing element, i.e. between the intermediate position and the second extreme position.

### BRIEF DESCRIPTION OF THE DRAWINGS

Aspects of the invention will hereafter be elucidated with reference to schematic drawings showing embodiments of the invention by way of example.

FIG. 1 is a perspective cut-away view of a part of an embodiment of the apparatus.

FIG. 2 is a similar view as FIG. 1, but showing the part of the embodiment as seen from below.

FIG. 3 is a similar view as FIG. 2, but showing a part thereof on a larger scale.

FIG. 4 is an illustrative plan view of the embodiment as shown in FIGS. 1-3.

FIG. 5 is a similar view as FIG. 4 of an alternative embodiment.

FIG. 6 is a perspective view of a part of an alternative embodiment of the apparatus.

### DETAILED DESCRIPTION OF THE ILLUSTRATIVE EMBODIMENTS

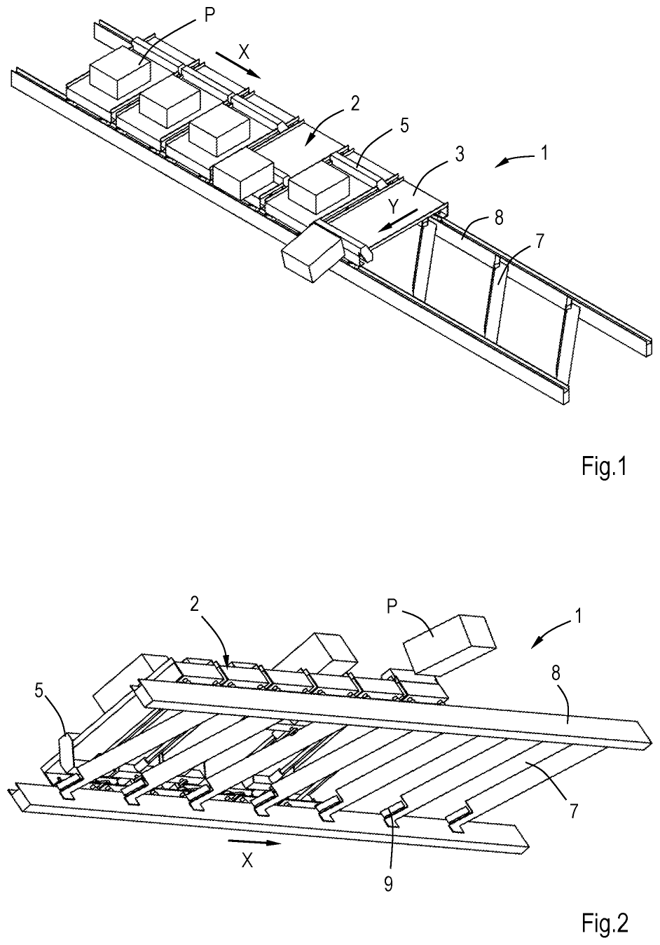

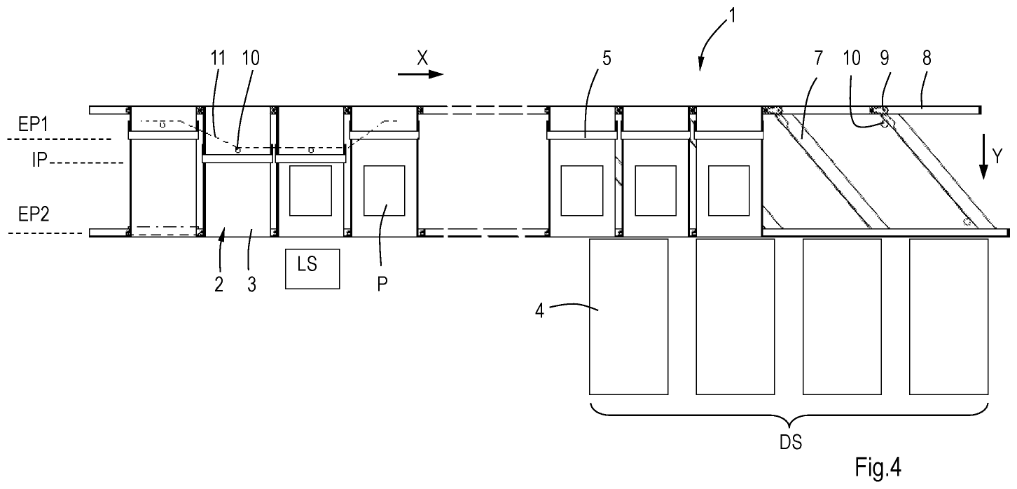

FIGS. 1 and 2 show a part of an embodiment of the apparatus as seen from above and below, respectively. The apparatus 1 is suitable for transport and controlled discharge of products P and comprises a plurality of transport units 2 for supporting and transporting products P. Each transport unit 2 has a tray 3 including an upper surface. In this case the apparatus 1 is arranged such that products P can be placed on the upper surfaces of the trays 3 at a loading station LS. The loading station LS is indicated in FIG. 4 and may represent a location where products P are placed onto the passing transport units 2 by an operator. FIG. 4 illustrates the functioning of the apparatus 1 by showing successive positions of a transport unit 2 in a single picture.

Under operating conditions the products P are transported in a conveying direction X from the loading station LS to a discharging station DS where the products P can be selectively discharged from the trays 3 of the respective transport units 2. The discharging station DS is provided with a plurality of exits or receiving units 4 for collecting products P intended for different destinations. The transport units 2 follow a closed loop track from the loading station LS to the discharging station DS and back to the loading station LS. Only a part of this track is shown in FIGS. 1-4. FIGS. 1-3 show a part of the apparatus 1 at the discharging station DS. The receiving units 4 are located behind each other in the conveying direction and next to the track.

The transport units 2 are coupled to each other and driven synchronously in the conveying direction X by a drive (not shown), for example a chain. In practice, the transport units 2 may be coupled to each other indirectly, for example each of the transport units 2 may be individually coupled to the driving means. The transport units 2 are pivotable with respect to each other such that a path which they follow may comprise bends in a horizontal plane. The path may be an endless path comprising two bends and two straight portions in a horizontal plane, but an alternatively shaped path is conceivable. It is also possible that the transport units 2 are also pivotable with respect to each other in a vertical plane such that a three-dimensional path can be followed.

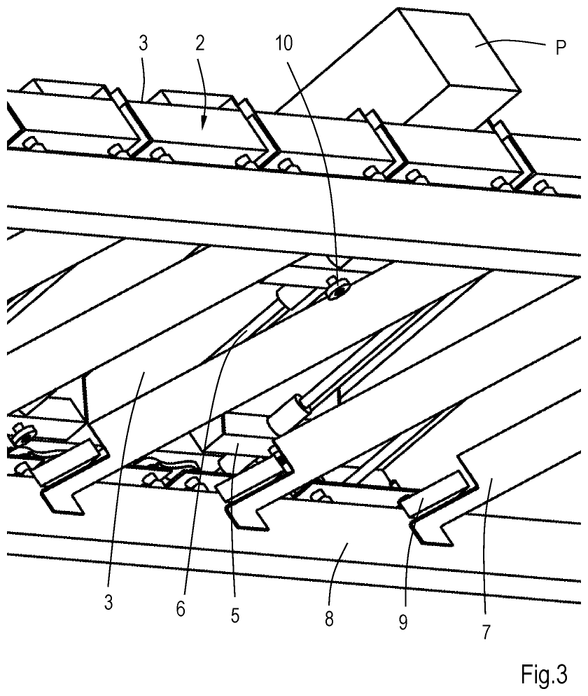

The apparatus 1 is adapted to discharge the products P at a selected receiving unit 4 at the discharging station DS in a controlled way. Each of the transport units 2 as shown in FIGS. 1 and 2 comprises a pushing member 5 which is moveable in a transverse direction Y which is perpendicular to the conveying direction X. This allows to push a product P from the upper surface of the tray 3 at a desired receiving unit 4 at the discharging station DS. The pushing member 5 has an elongated rigid bar which extends in the conveying direction X and is located above the tray 3. The pushing member 5 surrounds the tray 3 and below the tray 3 it is slidably mounted to a pushing member guide 6, see FIG. 3. The pushing member guide 6 comprises a rod which is located below the tray and suitable for guiding the pushing member 5 in the transverse direction Y between a first extreme position EP1 and a second extreme position EP2, which positions are illustrated in FIG. 4. When a product P has to be removed from the upper surface of the tray 3 at the discharging station DS the pushing member 5 is moved in a direction from the first extreme position EP1 to the second extreme position EP2. The first extreme position EP1 and the second extreme position EP2 are the maximum possible positions of the pushing member 5 which is allowable by the pushing member guide 6.

The apparatus 1 also comprises a control system for driving the pushing members 5 of the respective transport units 2 along the pushing member guides 6. The control system has a plurality of oblique guides 7 at the discharging station DS. Each of the oblique guides 7 is inclined with respect to the conveying direction X and is fixed to a frame 8 of the apparatus 1 at a level below the trays 3 of the transport units 2. The transport units 2 are moved on top of the frame 8 when they follow the closed loop track, for example by wheels (not shown).

The control system is further provided with guide actuators 9 which are located at front ends of the respective oblique guides 7. The front end of an oblique guide 7 is passed earlier by a transport unit 2 when travelling in the conveying direction X than an opposite rear end thereof. Each of the pushing members 5 is provided with an actuator wheel 10 which can be guided along the guide actuators 9 and the oblique guides 7. The guide actuators 9 are switchable between an inactive condition and an active condition. In the inactive condition the actuator wheel 10 of a passing transport unit 2 will not touch the corresponding guide actuator 9, which means that the corresponding pushing member 5 will not be displaced. In the active condition the actuator wheel 10 of a passing transport unit 2 will touch the corresponding guide actuator 9 and follow the corresponding oblique guide 7, forcing the pushing member 5 to move in the transverse direction Y. Under operating conditions, the guide actuators 9 are switched in dependence of the selected receiving unit 4 where a product P should be discharged. Hence, each of the oblique guides 7 cooperates with a single receiving unit 4 at the discharging station DS. The location where a product P leaves the tray 3 at a receiving unit 4 depends on the location where the product P is located on the tray 3 in the transverse direction Y. At the rear end of the oblique guide 7 the actuator wheel 10 leaves the oblique guide 7 and can be moved back such that the pushing member 5 returns to the first extreme position EP1. All pushing members 5 can be returned by a single return guide (not shown) which is located downstream of the discharging station DS. FIG. 4 illustrates the locations of the actuator wheels 10 at one of the oblique guides 7 when the corresponding pushing member 5 is at the first extreme position EP1 and the second extreme position EP2.

Referring to FIG. 4 the control system of the apparatus 1 is provided with an offset guide 11 which is partly located upstream of the loading station LS. The offset guide 11 is fixed to the frame 8 and extends below the trays 3 of the transport units 2 such that all of the passing actuator wheels 10 of the respective transport units 2 engage the offset guide 11. The offset guide 11 forces the pushing members 5 to an intermediate position IP upon arriving at the loading station LS. The intermediate position IP is between the first extreme position EP1 and the second extreme position EP2. FIG. 4 shows that in this case the intermediate position IP is closer to the first extreme position EP1 than the second extreme position EP2. The intermediate position IP of the pushing member 5 at the loading station LS provides a limited region of the upper surface of the tray 3 for placing a product P onto the transport unit 2. The limited region extends between the intermediate position IP and the second extreme position EP2.

FIG. 4 shows that downstream of the loading station LS the pushing members 5 are moved from the intermediate position IP back to the first extreme position EP1 by the offset guide 11, hence creating a larger space on the tray 3. Although the resulting extended space is not used for receiving products, this provides the opportunity to use standardized components of the apparatus 1, such as the oblique guides 7, the guide actuators 9 and the transport units 2. Alternatively, the offset guide 11, the oblique guides 7 and the guide actuators 9 may be adapted such that the positions of the pushing members 5 remain at the intermediate position IP between the loading station LS and the discharging station DS. It is even possible that the positions of the pushing members 5 are never between the first extreme position EP1 and the intermediate position IP along the closed-loop track.

The limited region at the loading station LS creates a well-defined area where the operator can place a product P. If the apparatus 1 is applied for products P having a maximum dimension which does not need the entire upper surface of the tray 3, the offset guide 11 can be adapted such that the specific products P to be transported and sorted always fit within the limited region. The pushing member 5 will only touch a product P on the tray 3 when moving within the limited region which corresponds to a certain length in the transport direction X where the product P may leave the transport unit 2. This length decreases with a decreasing limited region. Hence, in case of relatively small products the required lengths of the receiving units 4 can be shortened. This is shown in FIG. 4 where the length of each receiving unit 7 in the conveying direction X is shorter than the distance between two successive oblique guides 7. This is possible since the pushing member 5 will not touch a product P on the tray 3 when it travels from the first extreme position EP1 to the intermediate position IP.

FIG. 4 shows that the offset guide 11 starts to move the pushing member 5 to the intermediate position IP at a distance from the loading station LS such that it is in the intermediate position IP when arriving at the loading station LS.

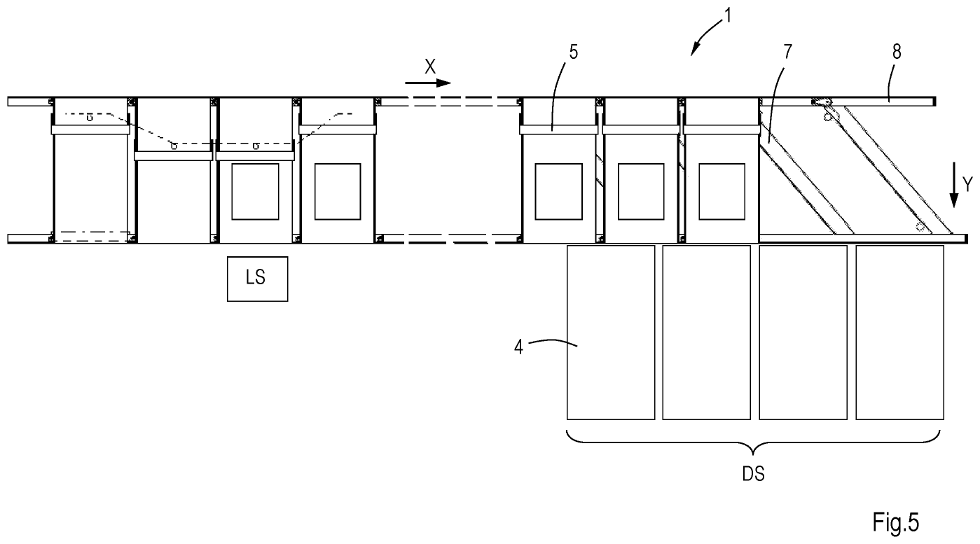

FIG. 5 shows an alternative embodiment in which the oblique guides 7 and the receiving units 4 are located closer to each other as seen in the conveying direction X than in the embodiment as shown in FIG. 4. This makes the discharging station DS of the apparatus 1 compact in the conveying direction X. The distance between two successive oblique guides 7 in the conveying direction X is smaller than a travelling distance of the transport unit 2 in the conveying direction X for displacing the pushing member 5 from the first extreme position EP1 to the second extreme position EP2.

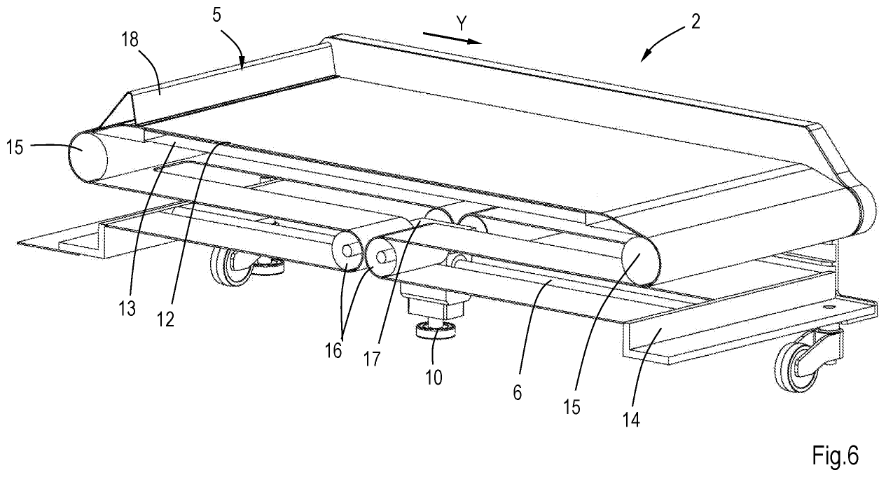

FIG. 6 shows a transport unit 2 of an alternative embodiment of the apparatus. In this case the pushing member 5 is provided with a pushing element 18 and with a flexible cross-belt 12 onto which the pushing element 18 is mounted, which cross-belt 12 is drivable in the transverse direction Y. The upper surface for supporting a product is formed by an upper surface of the cross-belt 12 next to the pushing element 18 such that the pushing element 18 is suitable for pushing against a product on the cross-belt 12 in the event that a product on the cross-belt 12 tends to move with respect to the cross-belt 12 in opposite direction of the direction in which the cross-belt 12 moves.

The pushing element 18 is shown as an elongate bar having a triangular cross-section, but alternative embodiments are conceivable. The cross-belt 12 is supported by a supporting plate 13 which is part of a transport unit frame 14 of the transport unit 2. The cross-belt 12 is guided by two freely rotating rollers 15 which are mounted to the transport unit frame 14 at opposite sides of the transport unit 2 and by four freely rotating rollers 16 which are mounted to a slider or a carriage 17 that is movable along the pushing member guide 6. The pushing member guide 6 comprises a rod which is located below the supporting plate 13 and suitable for guiding the pushing element 18 of the pushing member 5 in the transverse direction Y between the first extreme position EP1 and the second extreme position EP2. The rod is fixed to the transport unit frame 14 and extends in the transverse direction Y.

Opposite ends of the cross-belt 12 are fixed to the transport unit frame 14. Furthermore, the cross-belt 12 is partly divided in its transverse direction in order to allow the carriage 17 to move between the divided portions. The cross-belt 12 is drivable through the actuator wheel 10, which is mounted to the carriage 17 and which can be guided along an oblique guide 7 as explained hereinbefore in relation to the other embodiments of the apparatus 1. In the embodiment as shown in FIG. 6 the arrangement of the cross-belt 12, the rollers 15, 16 and the carriage 17 is such that a displacement of the carriage 17 in one direction leads to a double displacement of the pushing element 18 in opposite direction. Hence, when moving the actuator wheel 10 to the left in FIG. 6 the pushing element 18 will move to the right. Similar to the embodiments as described hereinbefore the actuator wheel 10 can be guided by the offset guide 11 in order to locate the pushing element 18 at least at the loading station LS at the intermediate position IP between the first extreme position EP1 and the second extreme position EP2. It is noted that numerous alternative types of cross-belt arrangements are conceivable.

Under operating conditions a product on the upper surface of the cross-belt 12 may be discharged from the upper surface by driving the cross-belt 12 without any contact between the pushing bar 18 and the product. However, the pushing element 18 is mounted to the cross-belt 12 for pushing against a product on the cross-belt 12 in the event that a product on the cross-belt 12 tends to move with respect to the cross-belt 12 opposite to the direction in which the cross-belt 12 moves, for example caused by rolling or slipping. Alternatively, it is even conceivable, that the pushing element 18 does not form a projecting element above the upper surface of the cross-belt 12, but only an indicator, such as a line, on the cross-belt 12 which indicates a border of the above-mentioned well-defined area where the operator can place a product on the cross-belt 12.

The invention is not limited to the embodiments shown in the drawings and described hereinbefore, which may be varied in different manners within the scope of the claims and their technical equivalents. For example, the pushing members may be activated in a different way than through actuator wheels, guide actuators and oblique guides as described hereinbefore.

What is claimed is:

1. An apparatus for transport and controlled discharge of products, comprising:
at least a transport unit including an upper surface for supporting a product,
a loading station where a product is placed on the upper surface,
a discharging station where a product is discharged from the upper surface, and
a drive for transporting the transport unit in a conveying direction from the loading station to the discharging station,
wherein the transport unit comprises:
a pushing member configured to push a product from the upper surface in a transverse direction of the conveying direction when the transport unit is at the discharging station,
a pushing member guide configured to guide the pushing member in the transverse direction between a first extreme position and a second extreme position for removing a product from the upper surface when the pushing member is moved in a direction from the first extreme position to the second extreme position, and
a control system configured to selectively drive the pushing member along the pushing member guide during movement of the transport unit in the conveying direction, wherein the control system is configured such that at least at the loading station the pushing member is located at an intermediate position between the first extreme position and the second extreme position.

2. The apparatus according to claim 1, wherein the intermediate position is closer to the first extreme position than the second extreme position.

3. The apparatus according to claim 2, wherein the control system is configured such that the pushing member is located at the first extreme position or between the first extreme position and the intermediate position when an actual position of the transport unit is upstream of the loading station.

4. The apparatus according to claim 1, wherein the control system is configured such that the pushing member is located at the first extreme position or between the first extreme position and the intermediate position when an actual position of the transport unit is upstream of the loading station.

5. The apparatus according to claim 1, wherein the control system is configured such that the pushing member is located at the first extreme position or between the first extreme position and the intermediate position when the transport unit arrives at the discharging station.

6. The apparatus according to claim 1, wherein the apparatus comprises a loop-shaped transport path such that the transport unit successively follows the transport path from the loading station to the discharging station and back to the loading station.

7. The apparatus according to claim 1, wherein the control system is provided with an offset guide which is located at least upstream of the loading station and configured such that offset guide guides the pushing member to the intermediate position upon passing the offset guide.

8. The apparatus according to claim 7, wherein the offset guide is configured such that the offset guide guides the pushing member from the first extreme position to the intermediate position upon passing the offset guide.

9. The apparatus according to claim 1, wherein the control system is provided with a plurality of oblique guides located at a distance from each other in the conveying direction at the discharging station and cooperating switchable guide actuators configured to selectively direct an actuator element of the pushing member of the passing transport unit to the corresponding oblique guide so as to guide the actuator element of the pushing member along the selected oblique guide upon passing the selected oblique guide.

10. The apparatus according to claim 9, wherein the apparatus is provided with receiving units at the discharging station for receiving discharged product, wherein a length of each of the receiving units in the conveying direction is smaller than a distance between two successive oblique guides in the conveying direction.

11. The apparatus according to claim 10, wherein the distance between two successive oblique guides in the conveying direction is smaller than a travelling distance of the transport unit in the conveying direction for displacing the pushing member from the first extreme position to the second extreme position.

12. The apparatus according to claim 11, wherein the distance between two successive oblique guides in the conveying direction is equal to or larger than a travelling distance of the transport unit in the conveying direction for displacing the pushing member from the intermediate position to the second extreme position.

13. The apparatus according to claim 9, wherein the distance between two successive oblique guides in the conveying direction is smaller than a travelling distance of the transport unit in the conveying direction for displacing the pushing member from the first extreme position to the second extreme position.

14. The apparatus according to claim 1, wherein the pushing member is provided with a pushing element for pushing a product from the upper surface in transverse direction of the conveying direction when the transport unit is at the discharging station and with a flexible cross-belt to which the pushing element is mounted, which cross-belt is drivable in the transverse direction.

15. The apparatus according to claim 12, wherein the cross-belt is configured such that the upper surface for supporting a product is formed by an upper surface of the cross-belt next to the pushing element such that the pushing element is suitable for pushing against a product on the cross-belt in an event that a product on the cross-belt tends to move with respect to the cross-belt in opposite direction of the direction in which the cross-belt moves.
